(19) United States
(12) Patent Application Publication
(10) Pub. No.: US 2013/0119932 A1
(43) Pub. Date: May 16, 2013

(54) BATTERY CHARGING APPARATUS

(71) Applicants: Tae Kyung MOON, Seoul (KR); Sun Min HWANG, Hwaseong-Si (KR); Hyung Tae MOON, Seoul (KR); Jun Young LEE, Yongin-si (KR); Hyung Jun CHAE, Gunpo-si (KR)

(72) Inventors: Tae Kyung MOON, Seoul (KR); Sun Min HWANG, Hwaseong-Si (KR); Hyung Tae MOON, Seoul (KR); Jun Young LEE, Yongin-si (KR); Hyung Jun CHAE, Gunpo-si (KR)

(73) Assignee: MANDO CORPORATION, Pyeongtaek-si (KR)

(21) Appl. No.: 13/603,093

(22) Filed: Sep. 4, 2012

(30) Foreign Application Priority Data
Sep. 2, 2011 (KR) 10-2011-0088900

(51) Int. Cl. H02J 7/00

(52) U.S. Cl. 320/109; 320/107

(57) ABSTRACT

A battery charging apparatus includes an input power processing unit configured to receive an AC power and convert the received AC power into an output voltage for power conversion; a hybrid power converting unit configured to use a common transformer to separately convert the output voltage of the input power processing unit into a first voltage and a second voltage for charging a high voltage battery and an auxiliary battery; a high voltage charging unit configured to drop the first voltage output from the hybrid power converting unit and charge the high voltage battery with the dropped first voltage; and an auxiliary voltage charging unit configured to generate an auxiliary voltage by dropping the second voltage output from the hybrid power converting unit or a voltage of the high voltage battery, and charge the auxiliary battery with the auxiliary voltage.

### CROSS-REFERENCE(S) TO RELATED APPLICATION

This application claims priority of Korean Patent Application No. 10-2011-0088900, filed on Sep. 2, 2011, in the Korean Intellectual Property Office, which is hereby incorporated by reference in its entirety.

### BACKGROUND OF THE INVENTION

1. Field of the Invention

The present invention relates to a battery charging apparatus, and more particularly, to a battery charging apparatus that commonly uses a power conversion structure in an on board charger (OBC) and a low voltage DC-DC converter (LDC), thereby reducing the size of the apparatus and increasing the efficiency thereof. Also, when a high voltage battery is charged by the AC power, the battery charging apparatus can generate an auxiliary voltage by the AC power and charge an auxiliary battery.

2. Description of the Related Art

Due to problems such as global warming caused by environmental destruction, high oil prices, and the like, the development of electric vehicles has recently been rapidly progressing in the automobile industry. Currently, major automobile manufactures around the world are conducting research and development to manufacture electric vehicles as their main vehicles.

Electric vehicles emit no exhaust gas and make a very small noise. Electric vehicles were manufactured earlier than gasoline vehicles in 1873. However, due to heavy batteries and long charging time, electric vehicles have not been put to practical use. Meanwhile, as pollution problems have become serious in recent years, electric vehicles are now being developed. However, since the number of times of use of rechargeable batteries is limited, the use of batteries alone cannot ensure a long distance drive.

Therefore, in the current markets, hybrid vehicles using two types of power sources, such as a fossil fuel and a battery, are actively on sale in the North America. Prius manufactured by Toyota Motor Corporation of Japan is a representative hybrid vehicle. Prius includes a gasoline engine, an alternator capable of converting kinetic energy recovered during the braking of a vehicle into electrical energy, and a motor.

Meanwhile, in the case of electric vehicles, methods of using a rechargeable battery (that is, an improvement in the performance of a secondary battery), a fuel cell having different characteristics from an existing cell, and the like, have been provided. Accordingly, the existing problems caused by a battery charging and a frequent replacement cycle in the electric vehicles have been gradually solved.

In the case of some small electric vehicles, not electric vehicles for general road drive, electric vehicles were already commercialized and are now widely used. For example, electric vehicles are widely used for golf carts in golf courses, vehicles for transporting players and equipments in stadiums, indoor drive vehicles, indoor cleaning vehicles, and the like, and it is expected that electric vehicles will be rapidly distributed and applied to commercial vehicles and sedans.

Electric vehicles and hybrid vehicles charges a high voltage battery mounted thereon and uses the high voltage battery as a power source. Vehicles are equipped with a high voltage battery for drive power, and an auxiliary battery for operating an electronic control unit (ECU).

As illustrated in FIG. 1, a conventional battery charging apparatus 1 includes an AC power 11, an on board charger (OBC) 12, an auxiliary battery 13, a high voltage battery 14, and a low voltage DC-DC converter (LDC) 15.

In order to charge the high voltage battery 14, the OBC 12 requires a high voltage charging unit 12a configured to convert the commercial AC power 11 into a high voltage.

However, the conventional battery charging apparatus 1 is designed to charge the high voltage battery 14 alone and consume the auxiliary battery 13 if an ECU using an ignition (IGN) power is operated during the charging.

Therefore, if the voltage of the auxiliary battery 13 is lowered, the battery charging apparatus 1 needs to operate the LDC 15 to charge the auxiliary battery 13. Also, since it is difficult to determine whether the auxiliary battery 13 needs to be charged, it is difficult to efficiently manage the voltage of the auxiliary battery 13.

Moreover, since the LDC 15 charges the auxiliary battery 13 with an auxiliary voltage through a process of converting a high voltage into a low voltage in the high voltage battery 14, the high voltage of the high voltage battery 14 is consumed. Therefore, the number of times of charging/discharging of the high voltage battery 14 is increased, shortening the lifespan of the high voltage battery 14.

### SUMMARY OF THE INVENTION

An aspect of the present invention is directed to a battery charging apparatus that is capable of charging both a high voltage battery and an auxiliary battery with a single AC power by commonly using a power conversion structure in an OBC.

According to an embodiment of the present invention, a battery charging apparatus includes: an input power processing unit configured to receive an AC power and convert the received AC power into an output voltage for power conversion; a hybrid power converting unit configured to use a common transformer to separately convert the output voltage of the input power processing unit into a first voltage and a second voltage for charging a high voltage battery and an auxiliary battery; a high voltage charging unit configured to drop the first voltage output from the hybrid power converting unit and charge the high voltage battery with the dropped first voltage; and an auxiliary voltage charging unit configured to generate an auxiliary voltage by dropping the second voltage output from the hybrid power converting unit or a voltage of the high voltage battery, and charge the auxiliary battery with the auxiliary voltage, wherein the high voltage charging unit and the auxiliary voltage charging unit charge the high voltage battery and the auxiliary battery by the AC power in a first mode, and charge the auxiliary battery by the voltage of the high voltage battery in a second mode, according to a control signal from a battery management system.

The input power processing unit, the hybrid power converting unit, the high voltage charging unit, and the auxiliary voltage charging unit may be mounted on an on board charger (OBC).

The transformer may include a primary winding, and a high voltage secondary winding and a low voltage secondary winding having turns ratios for the power conversion into the first voltage and the second voltage.

The high voltage charging unit may transfer the voltage of the high voltage battery to the high voltage secondary winding of the transformer in the second mode, and the auxiliary voltage charging unit may generate the auxiliary voltage by using a voltage induced in the low voltage secondary winding by the high voltage secondary winding, and charge the auxiliary battery with the auxiliary voltage.

The high voltage charging unit may include an H-bridge configured to perform a switching function to operate as a synchronous rectifier in the first mode and transfer the voltage of the high voltage battery to the auxiliary voltage charging unit in the second mode.

The H-bridge may perform the switching function according to the control signal output from the battery management system.

The control signal may be a phase shift PWM signal.

The high voltage charging unit may further include a leakage inductor between the high voltage secondary winding and the H-bridge.

The input power processing unit may include: a rectifying unit configured to perform a rectification operation to convert the AC power into a DC voltage; and a power factor correction (PFC) circuit configured to correct a power factor of the DC voltage and output the power-factor-corrected DC voltage as a high voltage for the power conversion.

The PFC circuit may include an interleaved buck converter.

The input power processing unit may further include: a DC link capacitor connected to the PFC circuit; an AC H-bridge configured to convert a DC voltage, which is connected to the DC link capacitor, into an AC voltage; and a resonance capacitor connected between the AC H-bridge and the primary winding of the hybrid power converting unit.

The high voltage charging unit and the auxiliary voltage charging unit may include interleaved buck converters.

The auxiliary voltage charging unit may include: a DC link capacitor connected to the buck converter; and a bridge diode connected to the DC link capacitor and the low voltage secondary winding of the hybrid power converting unit.

### BRIEF DESCRIPTION OF THE DRAWINGS

FIG. 1 is a block diagram of a conventional battery charging apparatus.

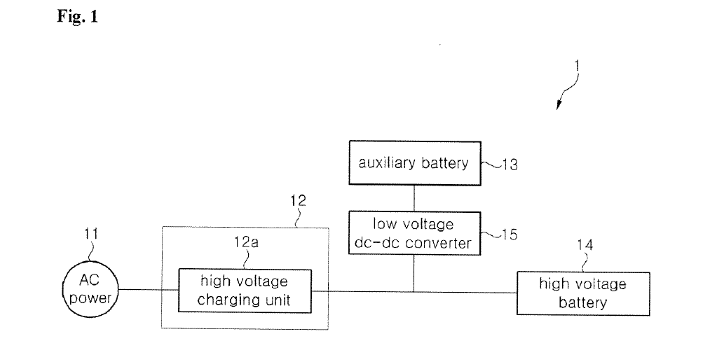

FIG. 2 is a block diagram of a battery charging apparatus according to an embodiment of the present invention.

FIG. 3 is a detailed circuit diagram of a battery charging apparatus according to an embodiment of the present invention.

FIG. 4 is a detailed circuit diagram of a battery charging apparatus according to an embodiment of the present invention.

FIG. 5 is a detailed circuit diagram of a battery charging apparatus according to another embodiment of the present invention.

<DESCRIPTION OF REFERENCE NUMERALS>

| | |
|---|---|
| 2: battery charging apparatus | 10: AC power |
| 20: high voltage battery | 30: auxiliary battery |
| 100: OBC | 110: input power processing unit |
| 111: rectifying unit | 112: PFC circuit |
| 113: DC link capacitor | 114: AC H-bridge |
| 115: resonance capacitor | 120: hybrid power converting unit |
| 121: primary winding | 122: high voltage secondary winding |
| 123: low voltage secondary | 130: high voltage charging unit |
| winding | |
| 131: leakage inductor | 132: high voltage H-bridge |
| 133: high voltage buck converter | 140: auxiliary voltage charging unit |
| 141: bridge diode (BD) | 142: DC link capacitor |
| 143: low voltage buck converter | 200: battery management system (BMS) |

### DETAILED DESCRIPTION OF EXEMPLARY EMBODIMENTS

Exemplary embodiments of the present invention will be described below in detail with reference to the accompanying drawings.

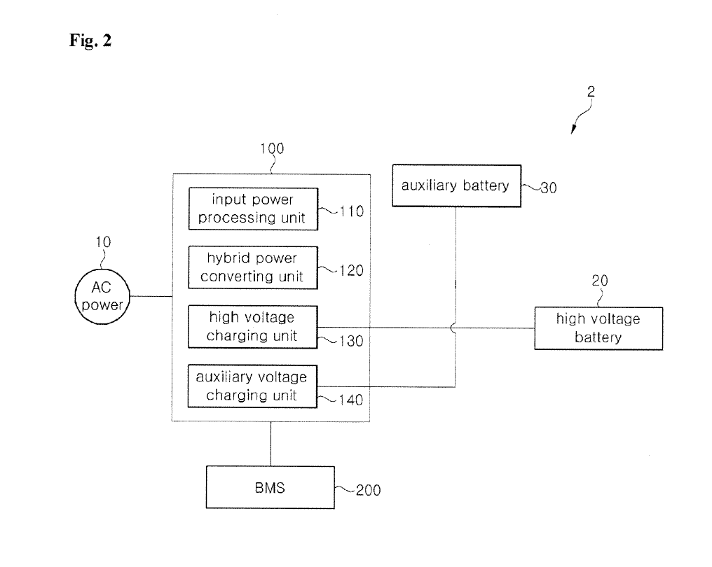

FIG. 2 is a block diagram of a battery charging apparatus according to an embodiment of the present invention.

Referring to FIG. 2, a battery charging apparatus 2 according to an embodiment of the present invention may be installed in an electric vehicle (EV) or a plug-in hybrid electric vehicle (PHEV). The battery charging apparatus 2 may convert an AC power (110V/220V) 10 into a high voltage and charge a high voltage battery 20 with the high voltage, and may generate an auxiliary voltage by converting the AC power 10 into a low voltage, and charge an auxiliary battery 30 with the auxiliary voltage. The high voltage battery 20 charged in this manner may be used as a power source of the EV or the PHEV, and the auxiliary battery 30 may be used to drive a variety of ECUs installed in the vehicle, for example, an ECU of a braking system, an ECU of a suspension system, an ECU of a steering system, and the like.

The battery charging apparatus 2 includes an AC power 10, an OBC 100, a high voltage battery 20, and an auxiliary battery 30.

Meanwhile, the components of the battery charging apparatus 2 may be integrally formed. Therefore, the battery charging apparatus 2 is easily mounted on the EV or the PHEV driven by electrical energy.

The OBC 100 may include an input power processing unit 110, a hybrid power converting unit 120, a high voltage charging unit 130, and an auxiliary voltage charging unit 140.

The hybrid power converting unit 120 includes a common transformer. The hybrid power converting unit 120 separately converts the AC power 10 into a first voltage and a second voltage for charging the high voltage battery 20 and the auxiliary battery 30 by using the transformer according to a charging instruction received from a battery management system (BMS) 200 installed in the vehicle. The transformer is commonly used for the power conversion into the first voltage and the second voltage for the high voltage charging unit 130 and the auxiliary voltage charging unit 140. The transformer has a high voltage secondary winding 122 and a low voltage secondary winding 123 having turns ratios corresponding to the power conversion of the high voltage charging unit 130 and the auxiliary voltage charging unit 140.

The high voltage charging unit 130 drops the first voltage output from the hybrid power converting unit 120 according to the charging instruction received from the BMS 200 installed in the vehicle, and charges the high voltage battery 20 with the dropped first voltage.

The auxiliary voltage charging unit 140 generates an auxiliary voltage by dropping the second voltage output from the hybrid power converting unit 120 by the AC power 10, and charges the auxiliary battery 30 with the auxiliary voltage.

The BMS 200 switches an electrical connection between the AC power 10 and the auxiliary voltage charging unit 140 and switches an electrical connection between the high voltage battery 130 and the auxiliary voltage charging unit 140, such that the second voltage generated by the AC power 10 or the voltage of the high voltage battery 20 is selectively input to the auxiliary voltage charging unit 140.

A first charging mode and a second charging mode may be performed by the hybrid power converting unit 120. The first charging mode is an AC power charging mode, in which the AC power 10 is supplied, the high voltage battery 20 is charged by the AC power 10, and the auxiliary battery 30 is supplementarily charged. The second charging mode is an AC power non-charging mode, in which the AC power 21 is not supplied and the auxiliary battery 30 is charged by the voltage of the high voltage battery 20 when the auxiliary battery 30 needs to be charged.

In the first charging mode in which the AC power 10 is input to the input power processing unit 110, the charging of the high voltage battery 20 and the charging of the auxiliary battery 30 by the AC power 10 are performed. In the second charging mode in which the AC power 10 is not input to the input power processing unit 110, the charging of the high voltage battery 20 by the AC power 10 is stopped and the charging of the auxiliary battery 30 by the voltage of the high voltage battery 20 is performed.

The operation of charging the high voltage battery 20 and the auxiliary battery 30 by the AC power 10 will be described below.

The OBC 100 receives an instruction to charge the high voltage battery 20 and the auxiliary battery 30 from the BMS 200. Accordingly, the input power processing unit 110 converts an AC voltage into a DC voltage such that the AC power 10 is input to the hybrid power converting unit 120. Then, the input power processing unit 110 boosts up the DC voltage to a high voltage and converts the high voltage into the AC voltage. The OBC 100 converts the AC power 10 into a first voltage through the hybrid power converting unit 120, and outputs the first voltage to the high voltage charging unit 130. The high voltage charging unit 130 drops the first voltage, and charges the high voltage battery 20 with the dropped first voltage. Meanwhile, the OBC 100 converts the AC power 10 into a second voltage through the hybrid power converting unit 120, and outputs the second voltage to the auxiliary voltage charging unit 140. The auxiliary voltage charging unit 140 generates the auxiliary voltage by dropping the second voltage, and charges the auxiliary battery 30 with the auxiliary voltage.

Meanwhile, the operation of charging the auxiliary battery 30 by the high voltage battery 20 will be described below.

The OBC 100 receives an instruction to charge the auxiliary battery 30 from the BMS 200. In this case, the AC power 10 is not input to an input terminal of the input power processing unit 110. The AC power 10 is not input to the high voltage charging unit 130 and the auxiliary voltage charging unit 140, and the power of the high voltage battery 20 is input to the auxiliary voltage charging unit 140.

Accordingly, the OBC 100 transfers the voltage to the high voltage secondary winding of the transformer, and induces a voltage in the low voltage secondary winding by the high voltage secondary winding. The voltage induced in the low voltage secondary winding is supplied to the auxiliary voltage charging unit 140. Accordingly, the auxiliary voltage charging unit 140 generates the auxiliary voltage by dropping the power of the high voltage battery 20, and charges the auxiliary battery 30 with the auxiliary voltage.

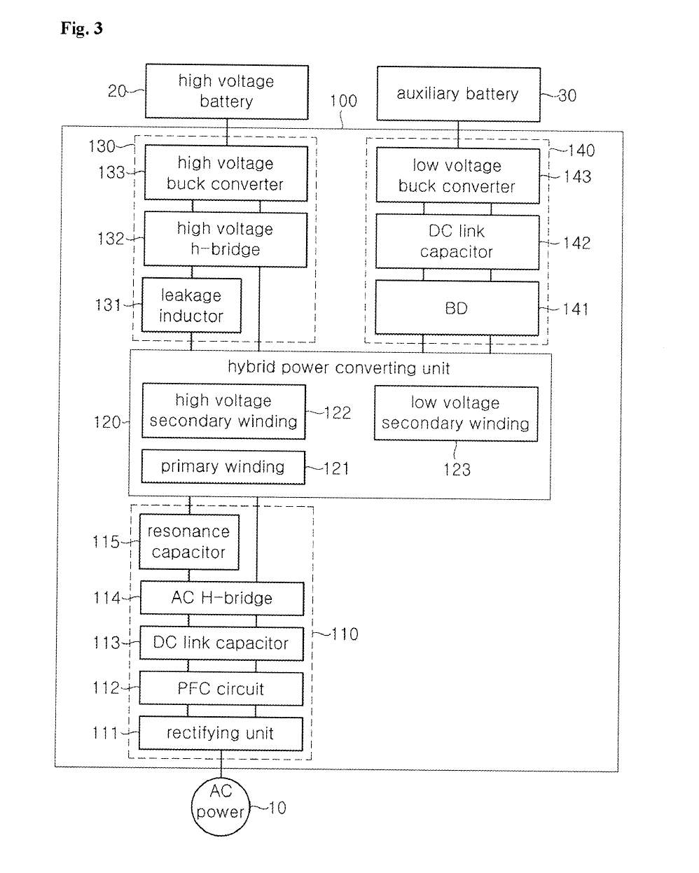

FIGS. 3 to 5 are detailed circuit diagrams of the battery charging apparatus according to the embodiment of the present invention.

Referring to FIGS. 3 to 5, the battery charging apparatus 2 may include an input power processing unit 110, a hybrid power converting unit 120, a high voltage charging unit 130, and an auxiliary voltage charging unit 140.

The battery charging apparatus 2 may include a rectifying unit 111 configured to perform a rectification operation to convert an AC power 10 into a DC voltage, a power factor correction (PFC) circuit 112 configured to correct a power factor of the DC voltage, a DC link capacitor 113, an AC H-bridge 114, and a resonance capacitor 114. The battery charging apparatus 2 may further include an electromagnetic interference (EMI) filter at a front end of the rectifying unit 111. Moreover, the battery charging apparatus 2 may further include a current control circuit and a voltage control circuit.

The rectifying unit 111 rectifies the AC power 10 and outputs the DC voltage.

The PFC circuit 112 corrects a power factor of the DC voltage output from the rectifying unit 111, and supplies the power-factor-corrected DC voltage to the hybrid power converting unit 120. The PFC circuit 112 may use an interleaved boost converter. The interleaved boost converter is a step-up converter in which an input terminal and an output terminal share the same ground. In the interleaved boost converter, when a switch is in an ON state, input power is connected to both terminals of an inductor so that a current is charged. On the other hand, when the switch is switched to an OFF state, the charged current is transferred to a filter of a load side. In the interleaved boost converter, when looking from the filter of the load side, the current is periodically flowed thereinto and interrupted. The current at the output terminal is always smaller than the current at the input terminal. Due to the principle of a circuit operation, there are no loss components. Therefore, from the relationship of “input current input voltage=output current output voltage”, the output voltage is always higher than the input voltage. When a duty ratio (D) is defined as “switch-on duration/switching period”, the output voltage (Vo) is expressed as Vo=Vi/(1−D). The output voltage of the PFC circuit 112 may be, for example, DC 480 V.

The DC link capacitor 113 is connected to the PFC circuit 112. The AC H-bridge 114 is connected to the DC link capacitor 113. The AC H-bridge 114 functions to convert a DC voltage into an AC voltage. The resonance capacitor 115 is connected between the AC H-bridge 114 and the primary winding 121 of the hybrid power converting unit 120. Accordingly, the AC H-bridge 114 and the resonance capacitor 115 operate an LLC primary circuit.

The hybrid power converting unit 120 includes a common transformer. The hybrid power converting unit 120 separately converts the AC power 10 into a first voltage and a second voltage for charging the high voltage battery 20 and the auxiliary battery 30 by using the transformer. The first voltage and the second voltage may be, for example, DC 480 V. The transformer is commonly used for the power conversion into the first voltage and the second voltage for the high voltage charging unit 130 and the auxiliary voltage charging unit 140. The transformer has a primary winding 121, and a high voltage secondary winding 122 and a low voltage secondary winding 123 having turns ratios corresponding to the power conversion of the high voltage charging unit 130 and the auxiliary voltage charging unit 140.

The high voltage charging unit 130 and the auxiliary voltage charging unit 140 may use step-down converters. For example, the high voltage charging unit 130 and the auxiliary voltage charging unit 140 may use interleaved buck converters 133 and 143. The buck converters 133 and 143 are used for a circuit in which an input terminal and an output terminal share the same ground. By using a switching element that performs a switching operation (repeats an ON/OFF operation) at a constant period, the input power is connected to the circuit when the switching element is in an ON state, and the input power is disconnected from the circuit when the switching element is in an OFF state. The high voltage charging unit 130 and the auxiliary voltage charging unit 140 output the DC voltages by using an LC filter to smooth (average) a pulse voltage that is periodically connected to and disconnected from the circuit.

The buck converter may basically employ a principle that generates the output voltage by averaging the pulse voltage produced by periodically chopping the DC voltage. Such a converter is called a voltage-fed converter, and the output voltage is always lower than the input voltage. As the switch-on duration of the switch in one period is longer, the width of the pulse voltage is further widened. As the switch-on duration of the switch in one period is shorter, the width of the pulse voltage is further narrowed. When a duty ratio (D) is defined as “switch-on duration/switching period”, the output voltage (Vo) becomes Vo=D*Vi.

The high voltage charging unit 130 may include a leakage inductor 131, a high voltage H-bridge 132, and a high voltage buck converter 133.

The leakage inductor 131 is connected between the high voltage secondary winding 122 and the high voltage H-bridge 132.

The high voltage H-bridge 132 may perform a switching function to operate as a synchronous rectifier in a first mode and transfer the voltage of the high voltage battery 20 to the auxiliary voltage charging unit 140 in a second mode. The high voltage H-bridge 132 may perform the switching function according to a control signal output from the BMS 200. In this case, the control signal may be a phase shift PWM signal.

The high voltage charging unit 130 drops the first voltage (480 V), which is output from the hybrid power converting unit 120, to a voltage of, for example, 250 V to 450 V, and charges the high voltage battery 130 with the dropped first voltage 30.

The auxiliary voltage charging unit 140 may include a bridge diode (BD) 141, a DC link capacitor 142, and a low voltage buck converter 143.

The bridge diode 141 is connected to the low voltage secondary winding 123 of the hybrid power converting unit 120. The bridge diode 141 rectifies an AC voltage output through the low voltage secondary winding 123, and outputs a DC voltage. The DC link capacitor 141 is connected to a rear end of the bridge diode 141.

The low voltage buck converter 143 converts the rectified DC voltage into a voltage for charging the auxiliary battery 30.

For example, the low voltage buck converter 143 generates an auxiliary voltage by dropping the second voltage (480 V), which is output from the hybrid power converting unit 120, to a voltage of, for example, 13.5 V, and charges the auxiliary battery 30 with the auxiliary voltage.

As such, an amount of current can be reduced by setting the output voltage of the PFC circuit 112 to 480 V and setting the first voltage output from the hybrid power converting unit 120 to a high voltage of 480 V. Also, the size of passive elements can be reduced and heat dispersion can be maximized by configuring the PFC circuit 112, the high voltage charging unit 130, and the auxiliary voltage charging unit 140 with the interleaved buck converters.

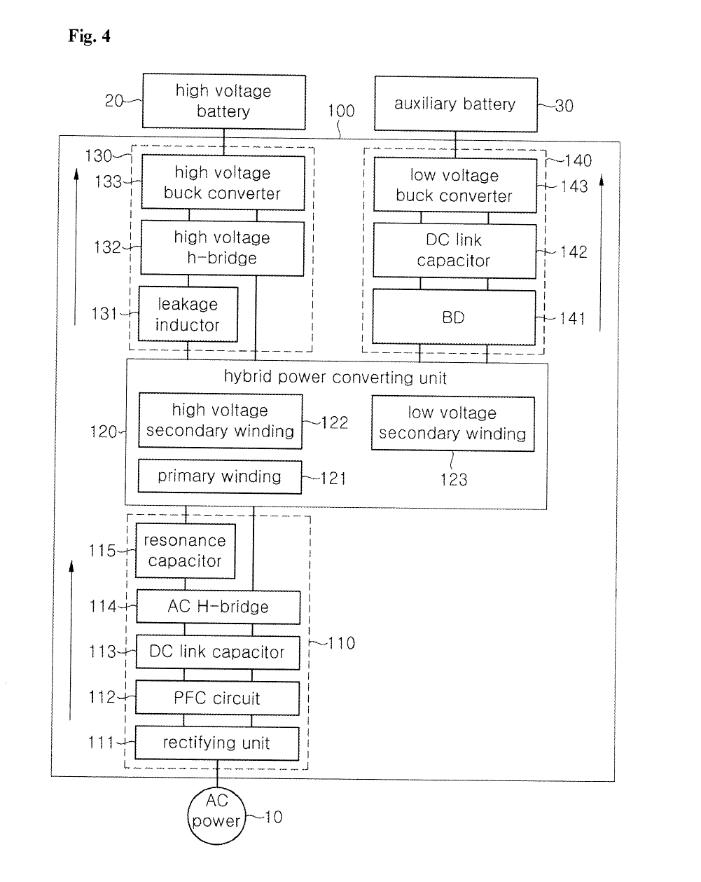

In such a configuration, the first charging mode operation of charging the high voltage battery 20 and the auxiliary battery 30 by the AC power 10 will be described below with reference to FIG. 4.

The OBC 100 receives an instruction to charge the high voltage battery 20 and the auxiliary battery 30 from the BMS 200. Accordingly, as illustrated in FIG. 4, the input power processing unit 110 is operated such that the AC power 10 is input to the hybrid power converting unit 120.

In the first charging mode, the AC power 10 is input to the hybrid power converting unit 120 through the rectifying unit 111, the PFC circuit 112, the DC link capacitor 113, the AC H-bridge 114, and the resonance capacitor 115. The hybrid power converting unit 120 converts the AC power 10 into the first voltage and outputs the first voltage to the high voltage charging unit 130. The high voltage charging unit 130 drops the first voltage by using the leakage inductor 131, the high voltage H-bridge 132, and the high voltage buck converter 133, and charges the high voltage battery 20 with the dropped first voltage. Meanwhile, the hybrid power converting unit 120 converts the AC power 10 into the second voltage and outputs the second voltage to the auxiliary voltage charging unit 140. The auxiliary voltage charging unit 130 generates the auxiliary voltage by dropping the second voltage by using the bridge diode (BD) 141, the DC link capacitor 142, and the low voltage buck converter 143, and charges the auxiliary battery 30 with the dropped second voltage.

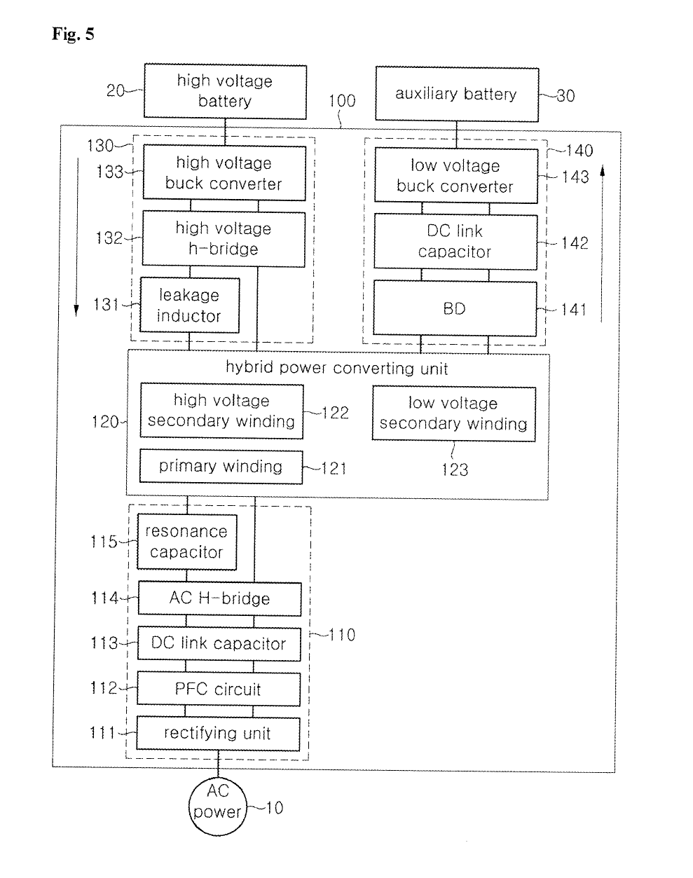

Meanwhile, the second mode operation of charging the auxiliary battery 30 by the high voltage battery 20 will be described below with reference to FIG. 5.

The OBC 100 receives an instruction to charge the auxiliary battery 30 from the BMS 200. Accordingly, a switching operation is performed such that the AC power 10 is not input to the hybrid power converting unit 120 and the power of the high voltage battery 20 is input to the auxiliary voltage charging unit 140.

In the second charging mode, the supply of the AC power 10 to the input power processing unit 110 is interrupted. Accordingly, the hybrid power converting unit 120 cannot perform the power conversion into the first voltage or the second voltage by the AC power 10. Therefore, the first voltage cannot be output to the high voltage charging unit 130, and the high voltage charging unit 130 cannot perform the operation of dropping the first voltage and charging the high voltage battery 20 with the dropped first voltage. Meanwhile, the hybrid power converting unit 120 cannot output the second voltage, which is generated by the AC power 10, to the auxiliary voltage charging unit 140.

However, the voltage of the high voltage battery 20 is transferred to the high voltage secondary winding 122 of the hybrid power converting unit 120 through the high voltage processing unit 130. The voltage of the high voltage battery 20, which is transferred to the high voltage secondary winding 122 of the hybrid power converting unit 120, is induced in the low voltage secondary winding 123 of the transformer provided in the hybrid power converting unit 120. The auxiliary voltage charging unit 140 generates the auxiliary voltage by dropping the voltage of the high voltage battery 20 induced in the low voltage secondary winding 123, and charges the auxiliary battery 30 with the auxiliary voltage.

According to the present invention, by commonly using the power conversion structure capable of transferring different power from the OBC and the LDC through the transformer having different turns ratios, the auxiliary voltage can be generated by AC power and can also be charged during the charging of the high voltage battery by the AC power.

Furthermore, according to the embodiments of the present invention, it is unnecessary to provide a separate LDC for charging the auxiliary battery, and the charging of the auxiliary battery is performed together during the operation of charging the high voltage battery by the AC power. Therefore, the charging time can be reduced, and the power transmission efficiency can be improved. Consequently, it is possible to prevent the lifespan of the high voltage battery from being shortened.

Moreover, according to the present invention, an amount of current may be reduced by setting the output voltage of the PFC circuit and the first voltage output from the hybrid power converting unit to a high voltage. The size of passive elements can be reduced and heat dispersion can be maximized by configuring the PFC circuit, the high voltage charging unit, and the auxiliary voltage charging unit with the interleaved buck converters.

While the embodiments of the present invention has been described with reference to the specific embodiments, it will be apparent to those skilled in the art that various changes and modifications may be made without departing from the spirit and scope of the invention as defined in the following claims.

What is claimed is:

1. A battery charging apparatus comprising:
an input power processing unit configured to receive an AC power and convert the received AC power into an output voltage for power conversion;
a hybrid power converting unit configured to use a common transformer to separately convert the output voltage of the input power processing unit into a first voltage and a second voltage for charging a high voltage battery and an auxiliary battery;
a high voltage charging unit configured to drop the first voltage output from the hybrid power converting unit and charge the high voltage battery with the dropped first voltage; and
an auxiliary voltage charging unit configured to generate an auxiliary voltage by dropping the second voltage output from the hybrid power converting unit or a voltage of the high voltage battery, and charge the auxiliary battery with the auxiliary voltage,
wherein the high voltage charging unit and the auxiliary voltage charging unit charge the high voltage battery and the auxiliary battery by the AC power in a first mode, and charge the auxiliary battery by the voltage of the high voltage battery in a second mode, according to a control signal from a battery management system.

2. The battery charging apparatus according to claim 1, wherein the input power processing unit, the hybrid power converting unit, the high voltage charging unit, and the auxiliary voltage charging unit are mounted on an on board charger (OBC).

3. The battery charging apparatus according to claim 1, wherein the transformer includes a primary winding, and a high voltage secondary winding and a low voltage secondary winding having turns ratios for the power conversion into the first voltage and the second voltage.

4. The battery charging apparatus according to claim 3, wherein the high voltage charging unit transfers the voltage of the high voltage battery to the high voltage secondary winding of the transformer in the second mode, and
the auxiliary voltage charging unit generates the auxiliary voltage by using a voltage induced in the low voltage secondary winding by the high voltage secondary winding, and charges the auxiliary battery with the auxiliary voltage.

5. The battery charging apparatus according to claim 4, wherein the high voltage charging unit includes an H-bridge configured to perform a switching function to operate as a synchronous rectifier in the first mode and transfer the voltage of the high voltage battery to the auxiliary voltage charging unit in the second mode.

6. The battery charging apparatus according to claim 5, wherein the H-bridge performs the switching function according to the control signal output from the battery management system.

7. The battery charging apparatus according to claim 6, wherein the control signal is a phase shift PWM signal.

8. The battery charging apparatus according to claim 5, wherein the high voltage charging unit further includes a leakage inductor between the high voltage secondary winding and the H-bridge.

9. The battery charging apparatus according to claim 1, wherein the input power processing unit includes:
a rectifying unit configured to perform a rectification operation to convert the AC power into a DC voltage; and
a power factor correction (PFC) circuit configured to correct a power factor of the DC voltage and output the power-factor-corrected DC voltage as a high voltage for the power conversion.

10. The battery charging apparatus according to claim 9, wherein the PFC circuit includes an interleaved buck converter.

11. The battery charging apparatus according to claim 9, wherein the input power processing unit further includes:
a DC link capacitor connected to the PFC circuit;
an AC H-bridge configured to convert a DC voltage, which is connected to the DC link capacitor, into an AC voltage; and
a resonance capacitor connected between the AC H-bridge and the primary winding of the hybrid power converting unit.

12. The battery charging apparatus according to claim 1, wherein the high voltage charging unit and the auxiliary voltage charging unit include interleaved buck converters.

13. The battery charging apparatus according to claim 12, wherein the auxiliary voltage charging unit includes:
a DC link capacitor connected to the buck converter; and
a bridge diode connected to the DC link capacitor and the low voltage secondary winding of the hybrid power converting unit.
